(19) United States
(12) Patent Application Publication
(10) Pub. No.: US 2022/0407772 A1
(43) Pub. Date: Dec. 22, 2022

(54) CONFIGURATION PROFILES

(71) Applicant: HEWLETT-PACKARD DEVELOPMENT COMPANY, L.P., Spring, TX (US)

(72) Inventors: Edward ETAYO, Spring, TX (US); Peter Siyuan ZHANG, Spring, TX (US); Alan Man Pan TAM, Spring, TX (US)

(21) Appl. No.: 17/349,607

(22) Filed: Jun. 16, 2021

(51) Int. Cl. H04L 12/24; G06F 3/0481; G06F 3/16; H04L 29/08; G06F 3/0484

(52) U.S. Cl. CPC H04L 41/0806; G06F 3/04817; G06F 3/165; H04L 67/306; H04L 41/0896; G06F 3/04842; H04L 41/22

(57) ABSTRACT

In some examples, an electronic device is provided. The electronic device comprises an audio device, an image sensor, a storage device storing a first and a second configuration profile, a display device to display a graphical user interface, and a processor. The first configuration profile is associated with a conferencing context, and the second configuration profile is associated with a security context. The graphical user interface has a first icon representing the first configuration profile and a second icon representing the second configuration profile. The processor is to, in response to a selection of the first icon, configure the audio device and the image sensor based on the first configuration profile. The processor is to, in response to a selection of the second icon, configure the audio device and the image sensor in accordance based on the second configuration profile.

### BACKGROUND

Electronic devices such as desktops, laptops, notebooks, tablets, and smartphones include applications (e.g., executable code, or machine-readable instructions that enable a user to perform related tasks) and hardware devices such as audio devices (e.g., a microphone, a speaker), image sensors (e.g., a camera), and network connectors that enable network connections. A user of an electronic device may configure states of the hardware devices (e.g., enabled/disabled) and states of the applications (e.g., executed, unexecuted) to have numerous, different configurations.

### BRIEF DESCRIPTION OF THE DRAWINGS

Various examples are described below referring to the following figures.

FIG. 1 is a schematic diagram of an electronic device including hardware devices having settings, in accordance with various examples.

FIG. 2 is a schematic diagram of an electronic device having configuration profiles, in accordance with various examples.

FIG. 3 is a schematic diagram of an electronic device having configuration profiles, in accordance with various examples.

FIG. 4 is a schematic diagram of an electronic device for configuring hardware devices and applications based on configuration profiles, in accordance with various examples.

FIG. 5 is an example of an electronic device displaying configuration profiles, in accordance with various examples.

### DETAILED DESCRIPTION

As described above, electronic devices such as desktops, laptops, notebooks, tablets, and smartphones include hardware devices and applications that have states that may be configured in numerous, different ways. For instance, the states may indicate whether a hardware device (e.g., audio devices, image sensors, network connections) is enabled or disabled and whether an application is executed or unexecuted. Users are able to configure states of hardware devices and applications in various ways. Having various techniques and differing locations for configuring the states of the hardware devices and the applications becomes confusing for the user and diminishes the user experience, and in instances where the user engages with an audience (e.g., videoconferencing, video calls, live streaming), diminishes the audience experience.

This description describes examples of an electronic device that includes configuration profiles for audio devices, image sensors, network connections, and applications. The configuration profile includes a user's preferences for which hardware devices and applications operate in different contexts. For example, the user may prefer to wear a headset in a videoconferencing context while in a video gaming context, the user may prefer to utilize external speakers and an internal microphone of the electronic device. The configuration profile includes a condition and settings for the hardware device(s) (e.g., audio devices, image sensors, network connections) and/or the applications operating under the condition. The condition is a state that may be met to implement the configuration profile. The condition may depend on an availability of a network connection, a bandwidth of an available network connection, an application executed, a type of the application executed, an availability of an audio device, an availability of an image sensor, a target level of security, or a combination thereof. The electronic device may include multiple configuration profiles. For example, the electronic device might include a first configuration profile for an application in use (e.g., a video conferencing application, a word processing application, a video streaming entertainment application), a second configuration profile for a network connection in use, a third configuration profile for a bandwidth of the network connection in use, a fourth configuration profile for a type of the application in use (e.g., videoconferencing, video streaming, music streaming), and a fifth configuration profile for a target level of privacy. The settings are target states of the audio devices, the image sensors, the network connections, and the applications operating under the condition. Responsive to a selection of a configuration profile from the multiple configuration profiles, the electronic device configures the states of the audio devices, the image sensors, the network connections, and applications to be equivalent to the settings of the selected configuration profile.

In some examples, a user may switch between configuration profiles utilizing an application having a graphical user interface (GUI) generated by machine-readable instructions. The application may include information about the configuration profiles. The information may include a condition, a state of an audio device, a state of an image sensor, a state of a network connection, a volume level of the audio device, a preview of an image captured by the image sensor, other data associated with the configuration profiles, or a combination thereof. In some examples, the user may switch between configuration profiles utilizing user commands (e.g., voice commands detected by an audio device, gestures detected by an image sensor, keyboard shortcuts detected by an input device).

In various examples, the electronic device may switch configuration profiles based on a condition indicated by the user command being met. For example, in response to a user command indicating a configuration profile having a condition based on an availability of a headset, the electronic device determines whether the headset is enabled. Responsive to the headset being enabled, the electronic device configures the states of the audio devices, the image sensors, the network connections, and the applications to be equivalent to the settings of the configuration profile. In other examples, the electronic device may cause the condition indicated by the command to be met before switching configuration profiles. For example, in response to a user command indicating a configuration profile having a condition based on an availability of a network connection, the electronic device determines whether the network connection is enabled. Responsive to the network connection being disabled, the electronic device enables the network connection. Responsive to the network connection being enabled, the electronic device configures the states of the audio devices, the image sensors, other network connections, and the applications to be equivalent to the settings of the configuration profile.

By providing the configuration profiles, the user experience is improved because, regardless of which application is in use and without switching between multiple applications and locations of an electronic device, the user is able to quickly switch the states of audio devices, image sensors, network connections, and applications. The audience experience is improved because, regardless of which application is in use, the user is able to quickly switch configuration profiles without hindering or delaying interactions with the audience.

In an example in accordance with the present description, an electronic device is provided. The electronic device comprises an audio device, an image sensor, a storage device storing a first and a second configuration profile, a display device to display a graphical user interface, and a processor. The first configuration profile is associated with a conferencing context, and the second configuration profile is associated with a security context. The graphical user interface has a first icon representing the first configuration profile and a second icon representing the second configuration profile. The processor is to, in response to a selection of the first icon, configure the audio device and the image sensor based on the first configuration profile. The processor is to, in response to a selection of the second icon, configure the audio device and the image sensor based on the second configuration profile.

In another example in accordance with the present description, an electronic device is provided. The electronic device comprises a storage device storing a configuration profile, where the configuration profile comprises a condition, an audio device to detect a selection of the configuration profile, and a processor. The processor is to, in response to detecting the selection of the configuration profile and a determination that the condition is met, configure an image sensor and the audio device based on the configuration profile.

In an example in accordance with the present description, a non-transitory machine-readable medium is provided. The non-transitory machine-readable medium storing machine-readable instructions which, when executed by a processor of an electronic device, cause the processor to receive a user command, determine that the user command is to enable a configuration profile, where the configuration profile comprises a condition. The processor is to, responsive to a determination that the condition is unmet, cause the condition to be met. The processor is to, responsive to the condition being met, configure a hardware device, executable code, or a combination thereof based on the configuration profile.

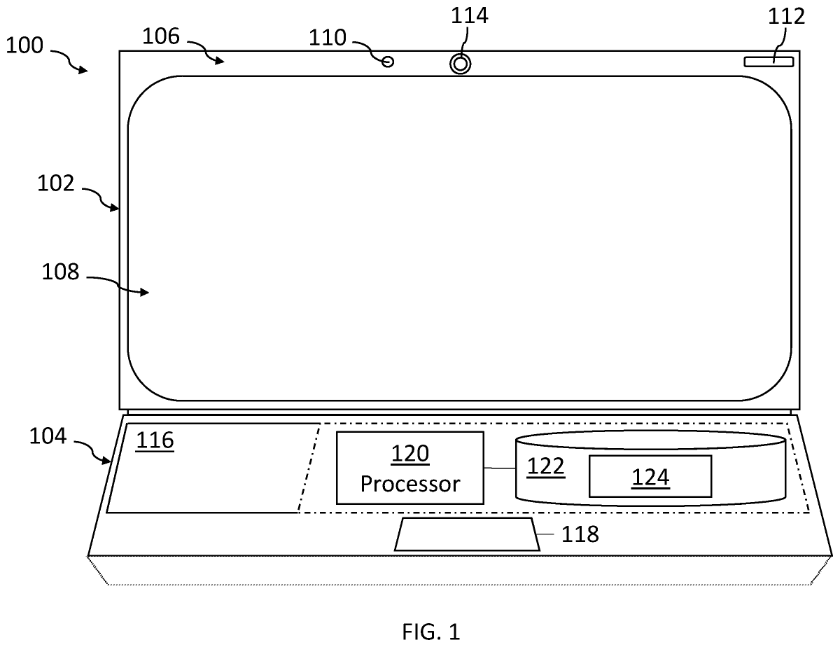

Referring now to FIG. 1, a schematic diagram of an electronic device 100 including hardware devices having settings is depicted in accordance with various examples. The electronic device 100 comprises a display device 102, a chassis 104, a bezel 106, a display panel 108, audio devices 110, 112, an image sensor 114, and input devices 116, 118. The electronic device 100 may be a desktop, a laptop, a notebook, a tablet, a smartphone, or other electronic computing device having audio devices, image sensors, or a combination thereof. The display device 102 may be any suitable display device for displaying data generated by the electronic device 100. The chassis 104 may house internal hardware components of the electronic device 100 such as a processor 120 and a storage device 122. The processor 120 may be a microprocessor, a microcomputer, a microcontroller, a programmable integrated circuit, a programmable gate array, or other suitable device for controlling operations of the electronic device 100. The storage device 122 may be a hard drive, a solid-state drive (SSD), flash memory, random access memory (RAM), or other suitable memory device. The bezel 106 may secure the display panel 108 of the display device 102 within a chassis of the display device. The display panel 108 may be configured as a touchscreen device for receiving inputs. The bezel 106 may be plastic, glass, glass coated with a conductive material, or some other suitable material for securing the display panel 108 of the display device 102. The bezel 106 may comprise the audio devices 110, 112 and the image sensor 114. The audio devices 110, 112 may be audio input devices such as microphones, headsets, or any suitable device for recording sound, audio output device such as speakers, headphones, or any suitable device for playing sound, or a combination thereof. The image sensor 114 may be a camera or any suitable device for recording images. The input device 116 may be a keyboard or any suitable device for receiving alphanumeric input. The input device 118 may be a touchpad or any suitable device for receiving pointer inputs.

While the audio devices 110, 112 and the image sensor 114 are described above as included in the bezel 106, in some examples, the audio devices 110, 112, the image sensor 114, or a combination thereof may be coupled to connectors of the electronic device 100. The audio devices 110, 112, the image sensor 114, or a combination thereof may be coupled via wired connections (not explicitly shown) or wireless connections (not explicitly shown). The wired connections (not explicitly shown) may include universal serial bus (USB) connections. The wireless connections (not explicitly shown) may include Wi-Fi® or Bluetooth®.

In some examples, the processor 120 couples to the display device 102, the audio devices 110, 112, the image sensor 114, the input devices 116, 118, and the storage device 122. The storage device 122 may store machine-readable instructions 124 that, when executed by the processor 120, may cause the processor 120 to perform some or all of the actions attributed herein to the processor 120. The machine-readable instructions may be the machine-readable instructions 124.

As described above, in various examples, the electronic device 100 includes configuration profiles having settings for the audio devices 110, 112, the image sensor 114, or a combination thereof. The configuration profiles may be stored on the storage device 122. The electronic device 100 may include multiple configuration profiles. For example, the electronic device 100 may include a configuration profile for a video conferencing application. The configuration profile for the video conferencing application may having settings that indicate that the target states of the audio devices 110, 112 and the image sensor 114 is enabled. The electronic device 100 may include a configuration profile for a word processing type of application. The configuration profile for the word processing type of application may having settings that indicate that the audio device 110 and the image sensor 114 are to be disabled and that the audio device 112 is to be enabled. The electronic device 100 may include a configuration profile for a network connection in use. The configuration profile for the network connection in use may having settings that indicate that the audio devices 110, 112 are to be enabled and that the image sensor 114 is to be disabled. The electronic device 100 may include a configuration profile for a bandwidth of a network connection in use. The configuration profile for the bandwidth of the network connection in use may have settings that indicate that the target states of the audio devices 110, 112 and the image sensor 114 is disabled. The electronic device 100 may include a configuration profile for a target level of privacy. The configuration profile for the target level of privacy may have settings that indicate that the audio device 110 is to be enabled and that the audio device 112 and the image sensor 114 are to be disabled.

In various examples, as described above, a user may switch between configuration profiles utilizing user commands. The processor 120 may detect a voice command utilizing the audio device 110. The voice command may be a keyword or phrase. For example, the user may say, “Switch to video conferencing configuration profile.” Responsive to the command, the processor 120 may switch the configuration profile to the video conferencing configuration profile and configure the audio devices 110, 112 and the image sensor 114 according to the settings of the video conferencing configuration profile. The processor 120 may detect a gesture utilizing the image sensor 114. The gesture may be a target gesture associated with a configuration profile. For example, the user may cover the image sensor 114. Responsive to the command, the processor 120 may switch from a first configuration profile having a setting that indicates that the target state of the image sensor 114 is enabled to a second configuration profile associated with a privacy context and having a setting that indicates that the target state of the image sensor 114 is disabled. The processor 120 may detect keystrokes utilizing the input device 116 or the display panel 108 that is configured as a touchscreen device. A first set of keystrokes may be associated with a first configuration profile and a second set of keystrokes may be associated with a second configuration profile, for example. In another example, the keystrokes may sequentially cycle through a list of configuration profiles. Responsive to the keystrokes, the processor 120 may switch from a first configuration profile to a second configuration profile.

By providing the multiple configuration profiles, the user experience is improved because, responsive to voice commands, user gestures, or keystrokes, and regardless of which application is in use, the user is able to quickly switch the states of audio devices and image sensors. The audience experience is improved because, regardless of which application is in use, the user is able to quickly switch configuration profiles without hindering or delaying interactions with the audience.

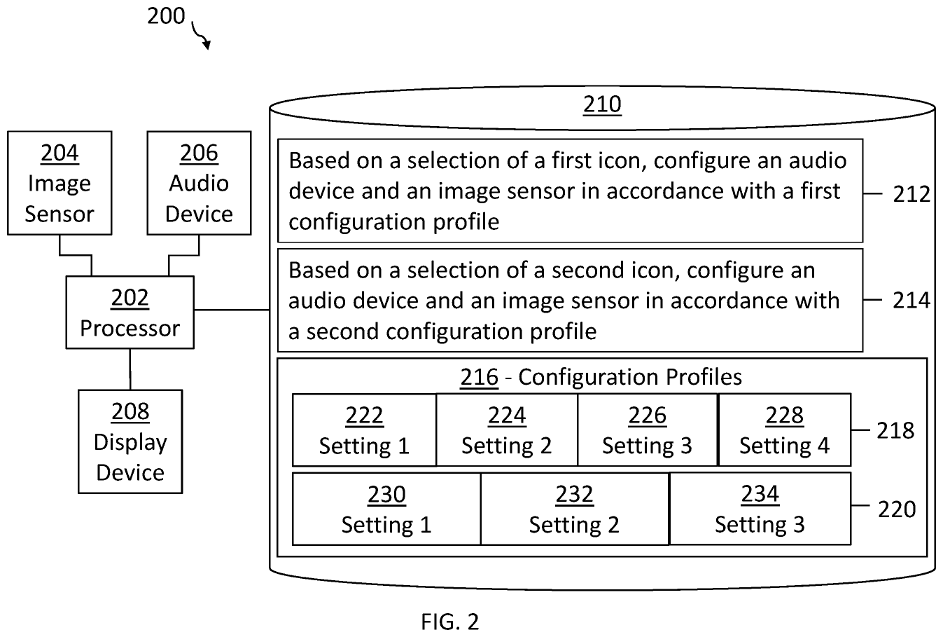

Referring now to FIG. 2, a schematic diagram of an electronic device 200 having configuration profiles 216 is depicted in accordance with various examples. The electronic device 200 comprises a processor 202, an image sensor 204, an audio device 206, a display device 208, and a storage device 210. The electronic device 200 may be the electronic device 100. The processor 202 may be the processor 120. The image sensor 204 may be the image sensor 114. The audio device 206 may be the audio device 110, 112. The display device 208 may be the display device 102. The storage device 210 may be the storage device 122.

In some examples, the processor 202 couples to the image sensor 204, the audio device 206, the display device 208, and the storage device 210. The storage device 210 may store configuration profiles 216 comprising a configuration profile 218, 220. The configuration profile 218 comprises settings 222, 224, 226, 228. The configuration profile 220 comprises settings 230, 232, 234. The storage device 210 may store machine-readable instructions that, when executed by the processor 202, may cause the processor 202 to perform some or all of the actions attributed herein to the processor 202. The machine-readable instructions may be the machine-readable instructions 124. The machine-readable instructions may be the machine-readable instructions 212, 214.

In various examples, the settings 222, 224, 226, 228, 230, 232, 234 store settings for hardware devices of the electronic device 200. The settings 222, 230 may be settings for the image sensor 204, the settings 224, 232 may be settings for the audio device 206, the settings 226, 234 may be settings for an application, and the setting 228 may be a setting for a type of application. The configuration profile 218 may be for a target level of security and the setting 228 indicates that a target state for a video conferencing type of application is disabled, for example. The settings 222, 230 may be settings for a network connector (not explicitly shown), setting 224 may be a setting for the audio device 206, the setting 232 may be a setting for a second audio device (not explicitly shown), setting 226 may be a setting for the image sensor 204, the setting 234 may be a setting for a second image sensor (not explicitly shown), and the setting 228 may be for an application. For example, the configuration profile 220 may be for a live streaming application and the setting 232 may be for an external microphone and the setting 234 may be for an external camera.

In various examples, when executed by the processor 202, the machine-readable instructions 212, 214 cause the processor 202 to configure the electronic device 200 based on a configuration profile of the configuration profiles 216. The machine-readable instruction 212 causes the processor 202 to, based on a selection of a first icon, configure the audio device 206 and the image sensor 204 based on a first configuration profile. The machine-readable instruction 214 causes the processor 202 to, based on a selection of a second icon, configure the audio device 206 and the image sensor 204 based on the second configuration profile.

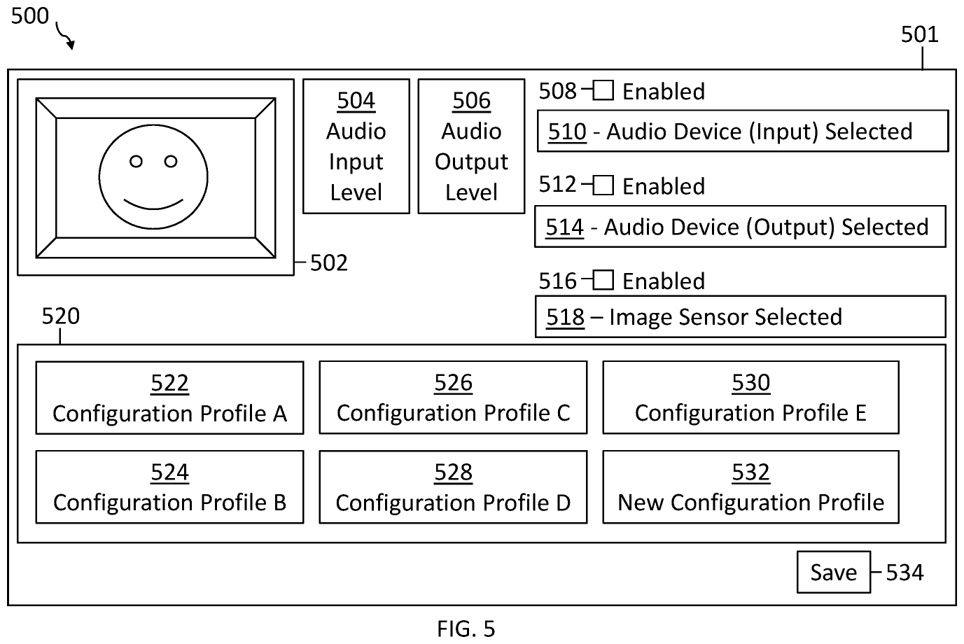

For example, as described above, the display device 208 is to display a GUI. The GUI may be the GUI described below with respect to FIG. 5. The configuration profile 218 is associated with a conferencing context, and the configuration profile 220 is associated with a security context. The GUI has a first icon representing the configuration profile 218 and a second icon representing the configuration profile 220. The processor 202 is to, in response to a selection of the first icon, configure the audio device 206 and the image sensor 204 based on the configuration profile 218. For example, the settings 222, 224 may indicate the target states of the image sensor 204 and the audio device 206, respectively, are enabled. Responsive to the selection of the first icon, the processor 202 enables the image sensor 204 and the audio device 206. The machine-readable instruction 214 causes the processor 202 to, based on a selection of the second icon, configure the audio device 206 and the image sensor 204 based on the configuration profile 220. For example, the settings 222, 224 may indicate the target states of the image sensor 204 and the audio device 206, respectively, are disabled. Responsive to the selection of the second icon, the processor 202 disables the image sensor 204 and the audio device 206.

By enabling switching between the configuration profile 218 and the configuration profile 220 utilizing a GUI, the user experience is improved because, regardless of which application is in use and without switching between multiple applications and locations to configure settings, the user is able to quickly switch the states of the audio device 206 and the image sensor 204. The audience experience is improved because, regardless of which application is in use, the user is able to quickly switch configuration profiles without hindering or delaying interactions with the audience.

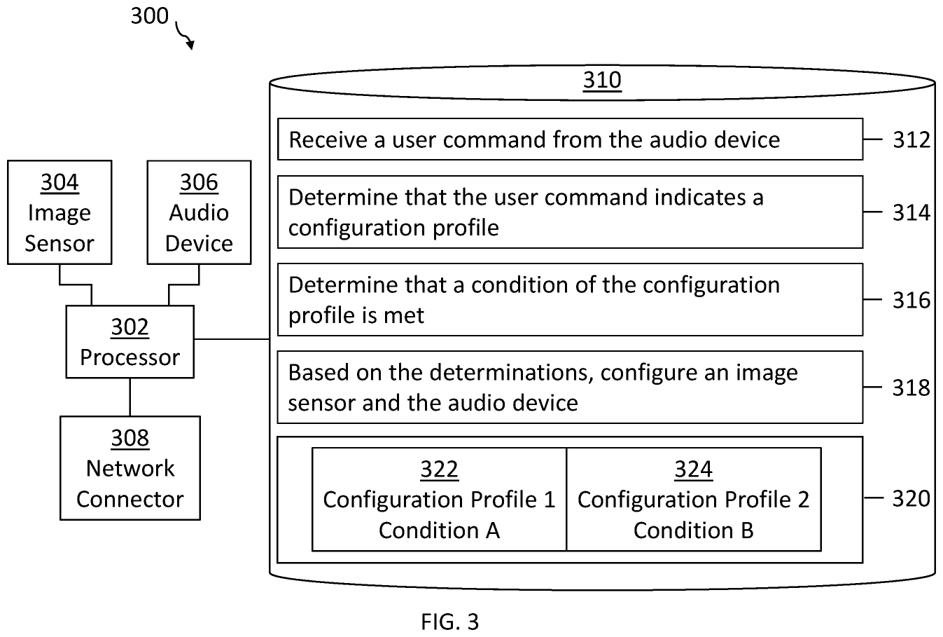

Referring now to FIG. 3, a schematic diagram of an electronic device 300 having configuration profiles 320 is depicted in accordance with various examples. The electronic device 300 comprises a processor 302, an image sensor 304, an audio device 306, a network connector 308, and a storage device 310. The electronic device 300 may be the electronic device 100, 200. The processor 302 may be the processor 120, 202. The image sensor 304 may be the image sensor 114, 204. The audio device 306 may be the audio device 110, 112, 206. The network connector 308 may be a connector for a wired or a wireless connection. The wired connection may include a universal serial bus (USB) connection utilizing a USB connector or an Ethernet connection utilizing an Ethernet connector. The wireless connection may be a Wi-Fi® connection or a Bluetooth® connection utilizing a wireless transceiver. The storage device 310 may be the storage device 122, 210.

In some examples, the processor 302 couples to the image sensor 304, the audio device 306, the network connector 308, and the storage device 310. The storage device 310 may store configuration profiles 320 that includes a configuration profile 322 and a configuration profile 324. The configuration profiles 320 may be the configuration profiles 216. The configuration profiles 322, 324 may be the configuration profiles 218, 220. In various examples, the configuration profiles 322, 324 include conditions under which the configuration profiles 322, 324 are enabled. For example, a condition of the configuration profile 322 may be that a network connection is private and a condition of the configuration profile 324 may be that an external headset is enabled. The storage device 310 may store machine-readable instructions that, when executed by the processor 302, may cause the processor 302 to perform some or all of the actions attributed herein to the processor 302. The machine-readable instructions may be the machine-readable instructions 124. The machine-readable instructions may be the machine-readable instructions 312, 314, 316, 318.

In various examples, when executed by the processor 302, the machine-readable instructions 312, 314, 316, 318 cause the processor 302 to configure the electronic device 300 based on a configuration profile of the configuration profiles 320. The machine-readable instruction 312 causes the processor 302 to receive a user command from the audio device 306. As described above with respect to FIG. 1, the user command may be received as a voice command detected by the audio device 306, as a user gesture detected by the image sensor 304, or as keystrokes detected by an input device (e.g., the input device 116 or the display panel 108 that is configured as a touchscreen device). As described above with respect to FIG. 2, the user command may be received as a selection (e.g., input from the input devices 116, 118, or the display panel 108 that is configured as a touchscreen device) of an icon of a GUI. The machine-readable instruction 314 causes the processor 302 to determine that the user command indicates a configuration profile. For example, the user may select an icon associated with the configuration profile 322. The machine-readable instruction 316 causes the processor 302 to determine that a condition of the configuration profile is met. For example, the configuration profile 322 may be associated with an entertainment context. The condition of the configuration profile 322 may be that the network connector 308 couples to a high-speed connection. The machine-readable instruction 316 causes the processor 302 to determine whether the network connector 308 couples to a high-speed network. The machine-readable instruction 318 causes the processor 302 to, based on the determination, configure the image sensor 304 and the audio device 306. For example, the configuration profile 322 having the entertainment context may have settings for the image sensor 304 and the audio device 306 that indicate the target states for the image sensor 304 and the audio device 306 are enabled. Based on the determination that the high-speed connection condition of the configuration profile 322 is met, the processor 302 configures the states of the image sensor 304 and the audio device 306 to enabled.

In various examples, the state of the audio device 306 or the state of the image sensor 304 may be disabled. However, the disabled states of the audio device 306 and the image sensor 304 may indicate a state of the audio device 306 or the image sensor 304 in relation to an application or a network connection. The audio device 306 and the image sensor 304 may be enabled at a system level. Disabling the audio device 306 and the image sensor 304 at the application level ensures a privacy of the user while still enabling the processor 302 to receive user commands.

As described above, in some examples, the electronic device 300 includes configuration profiles 320 having settings for the audio device 306, the image sensor 304, and the network connector 308. The configuration profiles 322, 324 include conditions. The conditions may depend on an availability of a network connection, a bandwidth of an available network connection, an application executed, a type of the application executed, an availability of an audio device, an availability of an image sensor, a target level of security, or a combination thereof. The electronic device may include multiple configuration profiles. For example, the electronic device 300 might include the configuration profile 322 for an application in use (e.g., a video conferencing application, a word processing application, a video streaming entertainment application) and the configuration profile 324 for a network connection in use.

In some examples, the processor 302, independent of a user command, may switch between configuration profiles 322, 324 based on a condition indicated by the configuration profile 322, 324, respectively, being met. For example, a condition of the configuration profile 322 may be that a headset is available to enable a first privacy context. The processor 302 determines whether the headset is enabled. Responsive to the headset being enabled, the processor 302 configures the states of the audio device 306, the image sensor 304, the network connector 308, and the applications of the electronic device 300 to the target states indicated by the settings of the configuration profile 322. In another example, a condition of the configuration profile 324 may be that, responsive to a network connection of the electronic device 300 being a public network connection, a second privacy context is enabled. The processor 302 determines whether the network connector 308 couples to a public network connection. Responsive to the determination that the network connector 308 couples to the public network connection, the processor 302 configures the states of the audio device 306, the image sensor 304, the network connector 308, and the applications of the electronic device 300 to the target states indicated by the settings of the configuration profile 324. In another example, the configuration profile 322 may have a condition associated with a default state. Responsive to a condition of the configuration profile 324 no longer being met, the processor 302 configures the states of the audio device 306, the image sensor 304, the network connector 308, and the applications of the electronic device 300 to the target states indicated by the configuration profile 322.

By responding to user commands, the user experience is improved because, regardless of which application is in use, the user is able to quickly switch the states of audio device 306 and image sensor 304. By providing the configuration profiles that are enabled when conditions of the configuration profiles are met, the user experience is improved because, regardless of which application is in use and without switching between multiple applications or locations, the user is able to quickly switch the states of the audio device 306, the image sensor 304, the network connector 308, and applications. By providing the configuration profiles that are automatically enabled when conditions of the configuration profiles are met, the user experience is improved because the processor 302 quickly switches the states of the audio device 306, the image sensor 304, the network connector 308, and applications independently of user action. The audience experience is improved because, regardless of which application is in use, the configuration profiles are quickly switched without hindering or delaying interactions with the audience.

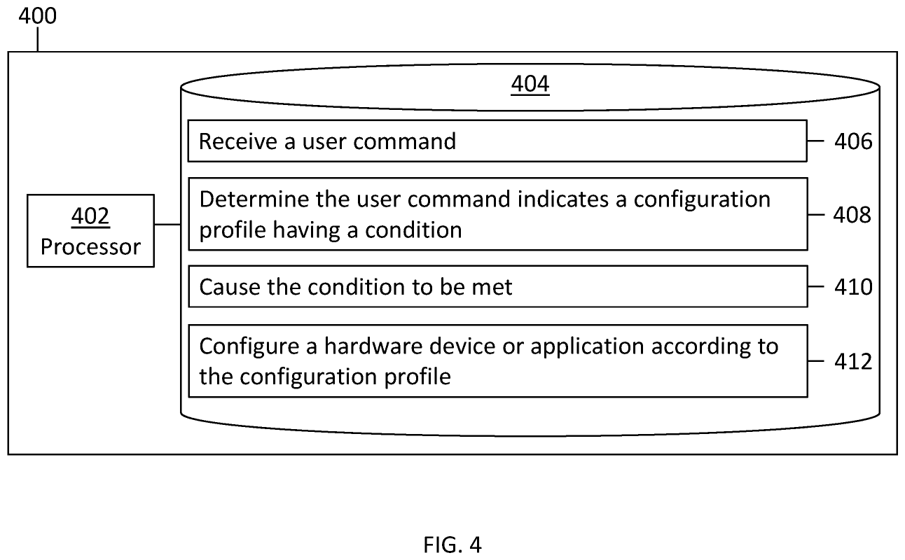

Referring now to FIG. 4, a schematic diagram of an electronic device 400 for configuring hardware devices (e.g., the audio device 110, 112, 206, 306, the image sensor 114, 204, 304, the network connector 308) and applications based on configuration profiles is depicted in accordance with various examples. The electronic device 400 comprises a processor 402 and the non-transitory machine-readable medium 404. The electronic device 400 may be the electronic device 100, 200, 300. The processor 402 may be the processor 120, 202, 302. The non-transitory machine-readable medium 404 may be the storage device 122, 210, 310. The term “non-transitory” does not encompass transitory propagating signals.

In various examples, the electronic device 400 comprises the processor 402 coupled to the non-transitory machine-readable medium 404. The non-transitory machine-readable medium 404 may store machine-readable instructions. The machine-readable instructions may be the machine-readable instructions 124. The machine-readable instructions may be the machine-readable instructions 406, 408, 410, 412. The machine-readable instructions 406, 408, 410, 412, when executed by the processor 402, may cause the processor 402 to perform some or all of the actions attributed herein to processor 402.

In various examples, when executed by the processor 402, the machine-readable instructions 406, 408, 410, 412 cause the processor 402 to configure a hardware device or executable code of the electronic device 400 according to a configuration profile. The machine-readable instruction 406 may cause the processor 402 to receive a user command. The processor 402 may receive the user command via techniques described above with respect to FIGS. 1-3. The machine-readable instruction 408 may cause the processor 402 to determine the user command indicates a configuration profile having a condition. The processor 402 may determine the user command is to enable the configuration profile having the condition via the techniques described above with respect to FIGS. 1-3. The machine-readable instruction 410 may cause the processor 402 to cause the condition to be met. For example, in response to a user command indicating a configuration profile having a condition based on an availability of a home network connection, the processor 402 determines whether the home network connection is enabled. Responsive to the home network connection being disabled, the processor 402 enables the home network connection. The machine-readable instruction 412 may cause the processor 402 to configure a hardware device or application of the electronic device 400 according to the configuration profile. For example, responsive to the home network connection being enabled, the processor 402 configures the states of the hardware devices (e.g., the audio device 110, 112, 206, 306, the image sensor 114, 204, 304, the network connector 308) and applications of the electronic device 400 to the target states indicated by the settings of the configuration profile having the home network connection enabled condition.

By the processor 402 causing the conditions of configuration profiles to be met, the user experience is improved because the processor 402 quickly switches the states of the hardware devices and applications of the electronic device 400 independently of additional user action. The audience experience is improved because, regardless of which application is in use, the configuration profiles are quickly switched without hindering or delaying interactions with the audience.

Referring now to FIG. 5, an example of an electronic device 500 displaying configuration profiles 522, 524, 526, 528, 530, 532 is depicted in accordance with various examples. FIG. 5 includes the electronic device 500 comprising an application window 501. The electronic device 500 may be the electronic device 100, 200, 300, 400. The application window 501 may be displayed on a display panel of a display device of the electronic device 500. The display panel may be the display panel 108 of the display device 102 or a display panel of the display device 208. The application window 501 comprises an image preview window 502, an audio input level 504, an audio output level 506, enablement boxes 508, 512, 516, an audio device (input) selected window 510, an audio device (output) selected window 514, an image sensor selected window 518, a configuration profile window 520, and a “Save” button 534. The configuration profile window 520 comprises configuration profiles 522, 524, 526, 528, 530, 532.

In various examples, the electronic device 500 displays the application window 501 in response to machine-readable instructions that, when executed by a processor (e.g., the processor 120, 202, 302, 402), cause the application for selecting configuration profiles to execute. The application for selecting configuration profiles may execute in response to a user selection of the GUI for the application, for example. In another example, the application for selecting configuration profiles may execute in response to another application (e.g., videoconference application) of the electronic device (e.g., the electronic device 100, 200, 300, 400) executing. In another example, the application for selecting configuration profiles may execute in response to a user command.

The image preview window 502 is a real-time display of a video signal of an image sensor. The image sensor may be the image sensor 114, 204, 304. The audio input level 504 and the audio output level 506 are volume levels of an active audio input device and an active audio output device, respectively. The active audio input device may be the audio device 110, 206, 306. The active audio output device may be the audio device 112, 206, 306. The audio device (input) selected window 510 indicates the active audio input device. The audio device (input) selected window 510 may indicate an internal microphone is active, and the audio input level 504 may indicate the volume level of the internal microphone. The audio device (output) selected window 514 indicates the active audio output device. The audio device (output) selected window 514 may indicate external speakers are active, and the audio output level 506 may indicate the volume level of the external speakers. The enablement boxes 508, 512, 516 may indicate whether devices associated with the enablement boxes 508, 512, 516, respectively, are enabled or disabled. The enablement box 508 may be associated with the audio input device indicated by the audio device (input) selected window 510. The enablement box 512 may be associated with the audio output device indicated by the audio device (output) selected window 514. The enablement box 516 may be associated with the image sensor indicated by the image sensor selected window 518.

In some examples, the audio device (input) selected window 510, the audio device (output) selected window 514, and the image sensor selected window 518 are menus. For example, a user may select a window to determine other devices available under the category. The audio device (input) selected window 510 may display an internal microphone, an external microphone, a headset having a microphone, a camera having a microphone, or any other suitable audio input device coupled to the electronic device 500. The audio device (output) selected window 514 may display internal speakers, external speakers, headphones, or any other suitable audio output device coupled to the electronic device 500. The image sensor selected window 518 may display an internal camera, an external camera, or any other suitable image sensor coupled to the electronic device 500.

In various examples, selecting an enablement box 508, 512, 516 enables/disables the device associated with the enablement box 508, 512, 516. The enablement boxes 508, 512, 516 may be boxes, buttons, or any other suitable user interface to select and deselect an option. For example, the user may select an internal microphone utilizing the audio device (input) selected window 510. The internal microphone may be muted, as indicated by an unselected enablement box 508. The user may interact with the enablement box 508 to unmute the internal microphone, as indicated by a mark, such as an “x,” appearing in the enablement box 508.

In some examples, a processor (e.g., the processor 120, 202, 302, 402) of the electronic device 500 determines that a configuration profile of the configuration profiles 522, 524, 526, 528, 530, 532 is selected. For example, the configuration profiles 522, 524, 526, 528, 530, 532 may be associated with buttons or any other suitable user interface to select an option. The processor may determine that the selected configuration profile of the configuration profiles 522, 524, 526, 528, 530, 532 is selected based on a user selection of the button associated with the selected configuration profile, as described above with respect to FIGS. 2-3. In other examples, the processor may determine that the configuration profile of the configuration profiles 522, 524, 526, 528, 530, 532 is selected based on another application executed. For example, responsive to a videoconferencing application executing, the processor may determine that the configuration profile associated with a conferencing context is selected. In various examples, the processor may determine that the configuration of the configuration profiles 522, 524, 526, 528, 530, 532 is selected based on a user command, as described above with respect to FIGS. 1-3.

In various examples, the user may interact with the “Save” button 534 to save a user modification to selections under a current configuration. For example, the configuration profile 530 may be associated with a security context. The user may select a new network connection from a list of network connections available in a network connection selection window (not explicitly shown). Selecting the “Save” button 534 updates the configuration profile 530. In other examples, the user may interact with the application window 501 to select hardware devices and their respective settings and then save the new configuration by selecting the configuration profile 532.

The above description is meant to be illustrative of the principles and various examples of the present description. Numerous variations and modifications become apparent to those skilled in the art once the above description is fully appreciated. It is intended that the following claims be interpreted to embrace all such variations and modifications.

In the figures, certain features and components disclosed herein may be shown in exaggerated scale or in somewhat schematic form, and some details of certain elements may not be shown in the interest of clarity and conciseness. In some of the figures, in order to improve clarity and conciseness, a component or an aspect of a component may be omitted.

In the above description and in the claims, the term “comprising” is used in an open-ended fashion, and thus should be interpreted to mean “including, but not limited to . . . ” Also, the term “couple” or “couples” is intended to be broad enough to encompass both direct and indirect connections. Thus, if a first device couples to a second device, that connection may be through a direct connection or through and indirect connection via other devices, components, and connections. Additionally, the word “or” is used in an inclusive manner. For example, “A or B” means of the following: “A” alone, “B” alone, or both “A” and “B.”

1. An electronic device, comprising:
an audio device;
an image sensor;
a storage device storing a first and a second configuration profile, wherein the first configuration profile is associated with a conferencing context, and wherein the second configuration profile is associated with a security context;
a display device to display a graphical user interface having a first icon representing the first configuration profile and a second icon representing the second configuration profile; and
a processor to:
in response to a selection of the first icon, configure the audio device and the image sensor based on the first configuration profile; and
in response to a selection of the second icon, configure the audio device and the image sensor based on the second configuration profile.

2. The electronic device of claim 1, wherein:
the storage device is to store a third and a fourth configuration profile, the third configuration profile associated with a privacy context and the fourth configuration profile associated with a security context;
the display device is to display the graphical user interface having a third icon representing the third configuration profile and a fourth icon representing the fourth configuration profile; and
the processor is to:
in response to a selection of the third icon, configure the audio device and the image sensor based on the third configuration profile; and
in response to a selection of the fourth icon, configure the audio device and the image sensor based on the fourth configuration profile.

3. The electronic device of claim 2, wherein the processor is to:
in response to the selection of the third icon, configure the audio device and the image sensor to have first and second states based on the third configuration profile; and
in response to the selection of the fourth icon, configure the audio device and the image sensor to have third and fourth states based on the fourth configuration profile, wherein the first and the second states are different from the third and the fourth states.

4. The electronic device of claim 1, wherein:
the security context of the second configuration profile is a first security context;
the storage device is to store a third configuration profile that is associated with a second security context;
the display device is to display the graphical user interface having a third icon representing the third configuration profile; and
the processor is to, in response to a selection of the third icon, configure the audio device and the image sensor based on the third configuration profile.

5. The electronic device of claim 1, wherein the processor is to, in response to the selection of the first icon, configure a network connector, executable code, or a combination thereof based on the first configuration profile.

6. An electronic device, comprising:
a storage device storing configuration profiles of the electronic device, the configuration profiles of the electronic device comprising a condition;
an audio device to detect a voice command, the voice command comprising a selection of a configuration profile from the configuration profiles; and
a processor to:
in response to the selection of the configuration profile and a determination that the condition is met, configure an image sensor and the audio device based on the selected configuration profile.

7. The electronic device of claim 6, wherein the condition is based on an availability of a network connection, a bandwidth of an available network connection, an application executed, a type of the application executed, an availability of an audio device, an availability of an image sensor, a target level of security, or a combination thereof.

8. The electronic device of claim 6, wherein:
the configuration profile is a first configuration profile comprising a first condition;
the storage device is to store a second configuration profile comprising a second condition;
the image sensor is to detect the second condition of the second configuration profile; and
the processor is to, in response to detecting the second condition of the second configuration profile, configure the image sensor and the audio device based on the second configuration profile.

9. The electronic device of claim 6, wherein:
the configuration profile is a first configuration profile comprising a first condition;
the storage device is to store a second configuration profile comprising a second condition, wherein the second condition is associated with a default state; and
the processor is to, in response to detecting the selection of the first configuration profile and a determination that the first condition is unmet, configure the image sensor and the audio device based on the second configuration profile.

10. The electronic device of claim 6, wherein:
the configuration profile is a first configuration profile comprising a first condition;
the storage device is to store a second configuration profile comprising a second condition; and
the processor is to, in response to a determination that the second condition is met, configure the image sensor and the audio device based on the second configuration profile.

11. A non-transitory machine-readable medium storing machine-readable instructions which, when executed by a processor of an electronic device, cause the processor to:
receive a user command;
determine that the user command is to enable a configuration profile, the configuration profile comprising a condition;
responsive to a determination that the condition is unmet, cause the condition to be met; and
responsive to the condition being met, configure a hardware device, executable code, or a combination thereof based on the configuration profile.

12. The non-transitory machine-readable medium of claim 11, wherein the user command is a voice command detected by an audio device, a gesture detected by an image sensor, keystrokes detected by an input device, a selection detected by an input device, or a combination thereof.

13. The non-transitory machine-readable medium of claim 11, wherein:
the configuration profile is a first configuration profile comprising a first condition;
the determination that the condition is unmet is a first determination; and
the machine-readable instructions, when executed by the processor, cause the processor to, in response to a second determination that the first condition is unmet, configure an image sensor and an audio device based on a second configuration profile.

14. The non-transitory machine-readable medium of claim 11, wherein:
the user command is a first user command;
the configuration profile is a first configuration profile comprising a first condition; and
the machine-readable instructions, when executed by the processor, cause the processor to:
receive a second user command;
determine that the second user command is to enable a second configuration profile, the second configuration profile comprising a second condition; and
responsive to a determination that the second condition is met, configure the hardware device, the executable code, or a combination thereof based on the second configuration profile.

15. The non-transitory machine-readable medium of claim 11, wherein:
the user command is a first user command;
the configuration profile is a first configuration profile comprising a first condition; and
the machine-readable instructions, when executed by the processor, cause the processor to:
determine that a second condition of a second configuration profile is met; and
responsive to the determination that the second condition is met, configure the hardware device, the executable code, or a combination thereof based on the second configuration profile.
